(19) United States
(12) Patent Application Publication
(10) Pub. No.: US 2025/0243383 A1
(43) Pub. Date: Jul. 31, 2025

(54) REPULPABLE REINFORCED WATER-ACTIVATED TAPE

(71) Applicant: INTERTAPE POLYMER CORP., Sarasota, FL (US)

(72) Inventors: John Kinch Tynan, Port Huron, MI (US); Richard Walter St. Coeur, Greenwood Township, MI (US); Jennifer M. Willson, Charlotte, NC (US); Nathan I. Isser, North Street, MI (US); Janis Gunars Matisons, East China, MI (US)

(73) Assignee: INTERTAPE POLYMER CORP., Sarasota, FL (US)

(21) Appl. No.: 18/855,612

(22) PCT Filed: Mar. 31, 2023
(86) PCT No.: PCT/US2023/017156

§ 371 Date: Oct. 9, 2024

Related U.S. Application Data
(60) Provisional application No. 63/329,860, filed on Apr. 11, 2022.

(51) Int. Cl. C09J 7/29; B32B 5/02; B32B 7/12; B32B 29/02; B32B 37/12; B32B 37/20; C09J 5/00; C09J 7/32; C09J 103/02

(52) U.S. Cl. CPC C09J 7/29; B32B 5/02; B32B 7/12; B32B 29/02; B32B 37/12; B32B 37/20; C09J 5/00; C09J 7/32; C09J 103/02; B32B 2255/12; B32B 2255/26; B32B 2262/02; B32B 2262/101; B32B 2315/085; B32B 2317/122; B32B 2405/00; C09J 2301/16; C09J 2301/306; C09J 2403/00

(57) ABSTRACT

Repulpable water-activated tapes, in particular reinforced laminated, water-activated paper tapes and methods of making the same are disclosed. The repulpable water-activated tape includes an outermost paper layer having a top surface and a bottom surface, a reinforcement adjacent to the bottom surface of the outermost paper layer, an innermost paper layer having a top surface and a bottom surface, the top surface of the innermost paper later adjacent to the reinforcement, at least a portion of a starch-based laminating adhesive disposed about each of the outermost paper layer, reinforcement, and innermost paper layer, and a water-activated adhesive adjacent to the bottom surface of the innermost paper layer. A repulpable starch-based laminating adhesive and tape comprising same is also described.

### Technical Field

This disclosure is directed to repulpable reinforced water-activated tape and the manufacture thereof.

### BACKGROUND

Adhesive tapes for sealing cartons or carton flaps during manufacture or after the carton is filled are well known. One of the most common constructions is a standard kraft paper tape which includes a water-soluble or water-activated adhesive on one side. Rolls of this tape can be dispensed through machines which rely on the longitudinal stiffness of the tape to unwind it from the roll and force it through a tape wetting device. Various improvements to this type of tape have been tried over the years, to meet differing requirements in the manufacture and sealing of cartons and environmentally sustainable goals of recyclability, with limited success.

### SUMMARY

In a first example, a water-activated tape is provided, comprising an outermost paper layer having a top surface and a bottom surface, a reinforcement adjacent to the bottom surface of the outermost paper layer, an innermost paper layer having a top surface, and a bottom surface, the top surface of the innermost paper layer adjacent to the reinforcement at least a portion of a starch-based laminating adhesive disposed about each of the outermost paper layer, reinforcement, and innermost paper layer, and a water-activated adhesive adjacent to the bottom surface of the innermost paper layer. In one example, the presently disclosed water-activated tape is at least 60% up to about 99% repulpable, using test procedure A that is specified in the 2013 Fibre Box Association Voluntary Standard for Repulping and Recycling Corrugated Fiberboard Treated to Improve Its Performance in the Presence of Water and Water Vapor (“FBA Standard”). In one example, the water-activated tape is at least 65%, 70%, 75%, 80%, 85%, 90%, 95%, 96%, 97%, 98%, or more than 99% repulpable. In one example, the presently disclosed tape is at least 60% up to about 99% repulpable. In one example, the presently disclosed water-activated tape has a yield of at least 60% up to about 99% per the FBA Standard. In one example, the water-activated tape has a yield of is at least 65%, 70%, 75%, 80%, 85%, 90%, 95%, 96%, 97%, 98%, or more than 99%.

In one aspect, one or both of the innermost paper layer and the outmost paper layer comprises bleached or natural kraft paper.

In one example, alone or in combination with any one of the previous aspects, the reinforcement comprises tape, ribbon, or yarn of polymer or glass. In one example, alone or in combination with any one of the previous aspects, the reinforcement comprises uni-, bi- or tri-directional tape, ribbon, or yarn of polymer, glass, or water-soluble polymer.

In one example, alone or in combination with any one of the previous aspects, the starch-based laminating adhesive comprises one or more botanical or synthetic starches; one or more botanical or synthetic starches in combination with one or more polymers; one or more of a synthetic starch, a chemically-, an enzymatically-, a mechanically-, a thermally-modified botanical starch and blends thereof; or one or more of a synthetic starch, a chemically-, an enzymatically-, a mechanically-, and a thermally-modified botanical starch blended with one or more polymers.

In one example, alone or in combination with any one of the previous aspects, the starch-based laminating adhesive is contiguous or semi-contiguous to the innermost paper layer, outermost paper, and the reinforcement.

In one example, alone or in combination with any one of the previous aspects, the starch-based laminating adhesive further comprises a crosslinker and optionally, a catalyst.

In one example, alone or in combination with any one of the previous aspects, the crosslinker comprises one or more of a melamine resin or melamine polymer, alkoxylated melamine resin, bezoquamine resin, glycouril resin, urea resin, glyoxal, sodium metaphosphate, and mixtures thereof.

In one example, alone or in combination with any one of the previous aspects, the catalyst is a blocked or unblocked sulfonic acid catalyst or mineral acid.

In one example, alone or in combination with any one of the previous aspects, the water-activated adhesive comprises one or more of a botanical and/or synthetic starch, a botanical and synthetic starch blended with one or more polymers, or chemically, enzymatically, mechanically or thermally modified botanical and synthetic starch, or chemically, enzymatically, mechanically or thermally modified botanical and synthetic starch blended with one or more polymers.

In one example, alone or in combination with any one of the previous aspects, the starch-based laminating adhesive: resists wetting during dispensing and activation of the water-activated adhesive; and has sufficient solubility for repulpability.

In a second example, a method of making a repulpable water-activated tape is provided, the method comprising introducing to a reinforcement at least one starch-based laminating adhesive: a top major surface of an innermost paper layer having a bottom major surface having a water-activated adhesive thereon; and a bottom major surface of an outermost paper layer, where the reinforcement is positioned between the top major surface of the innermost paper layer and the bottom major surface of the outermost paper layer.

In one example, the starch-based laminating adhesive is contiguous or semi-contiguous to the innermost paper layer, outermost paper, and the reinforcement.

In one example, alone or in combination with any one of the previous aspects, the starch-based laminating adhesive comprises: one or more botanical or synthetic starches; one or more botanical or synthetic starches in combination with one or more polymers; one or more of a synthetic starch, a chemically-, an enzymatically-, a mechanically-, a thermally-modified botanical starch and blends thereof; or one or more of a synthetic starch, a chemically-, an enzymatically-, a mechanically-, and a thermally-modified botanical starch blended with one or more polymers.

In one example, alone or in combination with any one of the previous aspects, the starch-based laminating adhesive further comprises a crosslinker and optionally, a catalyst.

In one example, alone or in combination with any one of the previous aspects, the crosslinker comprises one or more of a melamine resin or melamine polymer, alkoxylated melamine resin, bezoquamine resin, glycouril resin, urea resin, glyoxal, sodium metaphosphate, and mixtures thereof.

In one example, alone or in combination with any one of the previous aspects, the catalyst is a blocked or unblocked sulfonic acid catalyst or mineral acid.

In one example, alone or in combination with any one of the previous aspects, the water-activated adhesive comprises one or more of a botanical starch, synthetic starch, a chemically-, an enzymatically-, a mechanically-, a thermally-modified botanical starch, and blends thereof with one or more polymers.

In one example, alone or in combination with any one of the previous aspects, the one or both of the innermost paper layer and the outmost paper layer comprises bleached or natural kraft paper.

In one example, alone or in combination with any one of the previous aspects, the reinforcement comprises tape, ribbon, or yarn of polymer, glass, and/or water-soluble polymer. In one example, alone or in combination with any one of the previous aspects, the reinforcement comprises bi- or tri-directional tape, ribbon, and/or yarn of polymer, glass, or water-soluble polymer.

In one example, a starch-based laminating adhesive is provided, the adhesive comprising: one or more of a botanical starch and a synthetic starch; one or more of a botanical starch and synthetic starch combined with one or more polymers; one or more of a botanical starch, a synthetic starch, a chemically-, an enzymatically-, a mechanically-, and a thermally-modified botanical starch; or, one or more of a botanical starch, a synthetic starch, a chemically-, an enzymatically-, a mechanically-, a thermally-modified starch combined with one or more polymers.

### BRIEF DESCRIPTION OF THE DRAWINGS

In order to understand and to see how the present disclosure may be carried out in practice, examples will now be described, by way of non-limiting examples only, with reference to the accompanying drawings, in which:

FIG. 1 is a perspective view of a roll of tape for one example of the present disclosure.

FIG. 2 is an enlarged cross-sectional view of the tape of FIG. 1 along section line 2-2, illustrating the layers thereof.

FIG. 3 is an illustration of a tri-directional reinforcement.

FIG. 4 is an exemplary manufacturing process for providing the presently disclosed tape.

FIG. 5 is another exemplary manufacturing process for providing the presently disclosed tape.

### DETAILED DESCRIPTION

The presently disclosed water-activated tape (WAT) comprising a starch-based laminating adhesive. Starch is a plant-based polymer that is renewable, and so eliminates or reduces some or all of the disadvantages of conventional reinforced water-activated adhesive tape structures, for example, those that employ a non-renewable amorphous poly alpha olefin (APAO) laminating adhesive.

Previous attempts to add polymer films to tapes have been inadequate, at least for providing sustainability. In one aspect, the polymer film was used as the layer to carry the water-activated adhesive. The problem with this attempt is that the polymer film cannot hold a water-soluble or water activatable adhesive very effectively. In another aspect, polymer film was cold laminated to an innermost paper layer using an adhesive to develop a tape where the polymer could be stripped away after application because of the low bond strength provided by the adhesive between the polymer film and the innermost paper layer. Neither are desired characteristics for a water-activated paper tape. Thus, the disclosed water-activated paper tapes are an improvement over these previous attempts to use a polymer film in a water-activated tape.

The following detailed description will illustrate the general principles of the invention, examples of which are additionally illustrated in the accompanying drawings. In the drawings, like reference numbers indicate identical or functionally similar elements.

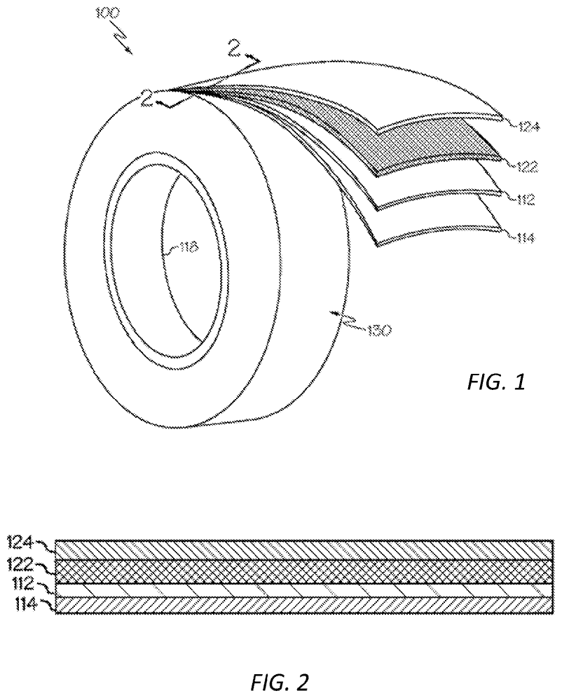

FIG. 1 illustrates a roll 130 of water-activated tape 100 wound onto a core 118. Referring to FIGS. 1 and 2 for explanation, from top to bottom relative to the page, the water-activated tape 100 includes an outermost paper layer 124, a reinforcement 122 and a starch-based laminating adhesive, an innermost paper layer 112, and a water-activated adhesive layer 114. The outermost paper layer 124 (also referred to as a substrate) has a first major (top) surface distal from the innermost paper layer 112, and a second major (bottom) surface proximal to the reinforcement 122. The outmost paper layer 124 has essentially an unlimited length, and has a width, and the second major (bottom) surface of the outermost paper layer 124 defines a thickness. In one example, the thickness of the outermost paper layer 124 is between 1.85 and 3.7 mil. In one example, the outermost paper layer 124 is printable by any method of printing of paper, and after printing, can be coated or treated to prevent smudging of the print.

Reinforcement 122 and starch-based laminating adhesive are introduced between the outermost paper layer 124 and innermost paper layer 112. Various means of introducing the laminating adhesive between the outermost paper layer 124 and innermost paper layer 112 can be used, such as blade coating, solvent dispensing, roll coating, extrusion, extrusion lamination, and the like. In one example, the starch-based laminating adhesive is present at a thickness of about 0.1 mil to about 2 mil. In another example, the starch-based laminating adhesive is present at a thickness of about 0.5 mil (12.7 micron) to about 1.3 mil (32.5 micron). The to-be laminated surfaces of the corresponding paper layers 112, 124 and/or the reinforcement 122 can be pretreated using such methods as corona or flame treatment to ensure or enhance adhesion.

In one example, the starch-based laminating adhesive is contiguous to the innermost paper layer 112, the outermost paper layer 124, and/or the reinforcement 122. In one example, the starch-based laminating adhesive is semi-contiguous to the innermost paper layer 112, the outermost paper layer 124, and/or the reinforcement 122. In one example, the starch-based laminating adhesive at least partially fills all or some voids or gaps in the reinforcement 122.

In one example, after lamination, the reinforcement 122 is adjacent to the second major (bottom) surface of the outermost paper layer 124. In one example, after lamination, the reinforcement 122 is directly adjacent to the second major (bottom) surface of the outermost paper layer 124, whereas there are no intervening layers or material therebetween.

In one example, after lamination, the reinforcement 122 is adjacent to the first major (top) surface of the innermost paper layer 112. In one example, after lamination, the reinforcement 122 is directly adjacent to the first major (top) surface of the innermost paper layer 112, whereas there are no intervening layers or material therebetween.

In one example, after lamination, the reinforcement 122 is directly adjacent to the second major (bottom) surface of the outermost paper layer 124 and directly adjacent to the first major (top) surface of the innermost paper layer 112, whereas there are no intervening layers or material therebetween.

In one example, the starch-based laminating adhesive is a synthetic or a botanic starch, or blends thereof. In one example, the starch-based laminating adhesive comprises one or more botanical or synthetic starches in combination with one or more polymers. As used herein, “botanical starch” is starch isolated, derived, and or purified from any botanical source by any means. In one example, the botanical starch is derived or obtained from, but not limited to, cassava, corn, sorghum, wheat, sago, tapioca, legumes, barley, rice, and/or potatoes. Other sources of botanical and non-botanical starch can be employed.

As used herein, synthetic starch is inclusive of “modified botanical starch” e.g., any botanical starch that is modified chemically, genetically, enzymatically, mechanically and/or thermally. As used herein, synthetic starch is also inclusive of non-botanical starch, e.g., starch prepared from carbon dioxide.

In one example, the starch-based laminating adhesive comprises one or more of a synthetic or a botanical starch blended with one or more polymers. In one example the starch-based laminating adhesive comprises a thermoplastic starch (TPS) that is destructurized and/or plasticized. In one example the TPS is melt processable, e.g., will flow at elevated temperature and pressure and can be extruded. For example, starch-based laminating adhesives are inclusive of starch-polyester, starch-polycaprolatone, starch-cellulose acetate, esterified starch and blends thereof. In one example, the starch-based laminating adhesive is a synthetic and/or a botanically derived starch combined or blended with a polyacrylic acid polymer or copolymer. One or more plasticizers, fillers, additives, processing aids, etc., can be used with the starch-based laminating adhesive.

In one example the starch comprises an amylose: amylopectin ratio of about 0:100 to about 30:70.

Starch-based laminating adhesive may be applied to innermost paper layer 112, the outermost paper layer 124, and/or the reinforcement 122 as an aqueous or non-aqueous solvent-cast, solventless, or as molten film or as a coating layer using either extrusion, any manner of roll, knife, rod, die, or blade coating, curtain coating or any suitable coating method.

In one example, the starch-based laminating adhesive, after deployment between the paper and/or reinforcement, is allowed to dry or heated to promote removal of water and/or other volatile material. In one example, the starch-based laminating adhesive, after deployment between the paper and/or reinforcement, is crosslinked alone or in combination with drying and/or heating. In one example, the starch-based laminating adhesive is crosslinked with an amine resin. In one example, the starch-based laminating adhesive is crosslinked with an amine resin and a catalyst. In one example, after lamination, the starch-based laminating adhesive is resistant to being remoistenable, and does not substantially rewet upon exposure of the water-activated tape, after dispensing, to rain/snow, however, the starch-based laminating adhesive is substantially or completely repulpable.

In one example, the water-activated tape, with the starch-based laminating adhesive and reinforcement of the present disclosure, has sufficient water resistance that the integrity of the tape is at least partially maintained when the water-activated tape is dispensed and activated. Sufficient water resistance is at least the ability to resist the separation of paper layers, upon rewet during dispensing of the tape. Once applied to a carton, the paper plies of the tape resist separation in wet conditions, for at least 2 hours. In one example, sufficient water resistance refers to no delamination of either the inner or the outer paper layer to the reinforcement upon full immersion soak in water for up to two hours.

Likewise, the water-activated tape, with the starch-based laminating adhesive and reinforcement of the present disclosure, has sufficient water resistance that the integrity of the tape is maintained when the water-activated tape, after dispensing with water activation and application to a carton, is subsequently exposed to environmental moisture. Sufficient water resistance of the tape adhesion to the carton is at least the ability to resist delamination of the tape from the carton upon full immersion soak in water for up to two hours. The water-activated tape, with the starch-based laminating adhesive and reinforcement of the present disclosure has sufficient water resistance yet is substantially repulpable.

In one example, the water-activated tape is at least 60% up to about 99% repulpable. In one example, the water-activated tape is at least 65%, 70%, 75%, 80%, 85%, 90%, 95%, 96%, 97%, 98%, or more than 99% repulpable. In one example, the tape (including any reinforcement) would be deemed at least 60% up to about 99% repulpable as per the FBA method. In one example, the tape and the carton to which it is associated with is would be deemed at least 60% up to about 99% repulpable. In one example, the tape itself would be deemed at least about 60% to about 75% repulpable as per the FBA method.

In one example, the starch-based laminating adhesive is substantially devoid of a crosslinker. In one example, the starch-based laminating adhesive comprises a crosslinker. In one example, crosslinker is a melamine resin (or melamine polymer). In one example, the crosslinker is an imino melamine resin. In one example, the amine resin is a methylated imino melamine resin. In one example, the amine resin is an alkoxylated melamine resin.

Examples of amine resin suitable as a crosslinker for the presently disclosed starch-based laminating adhesive includes methylated melamine formaldehyde, methoxymethylated melamine, ethoxymethylated melamine, propoxymethylated melamine, butoxymethylated melamine, hexamethylol melamine, ethoxymethylated melamine, propoxymethylated melamine, and butoxymethylated melamine. Examples of highly methylated melamine resins include CYMEL® 303, 350, 9370; methylated imino melamine resins, partially methylolated and highly alkylated such as CYMEL® 323, 327; partially methylated melamine resins (highly methylated/alkoxylated and/or partially methylated/alkoxylated) such as CYMEL® 385, 373, 370; high solids mixed ether melamine resins such as CYMEL® 1130, 324; n-butylated melamine resins such as CYMEL® 1151, 615; n-butylated high imino melamine resins such as CYMEL® 1158; and iso-butylated melamine resins such as CYMEL® 255-10. CYMEL melamine resins are commercially available from Solvay (Rock Hill, SC). In one example, methylated formaldehyde-melamine resin, methoxymethylated melamine resin, ethoxymethylated melamine resin, propoxymethylated melamine resin, butoxymethylated melamine resin, hexamethylol melamine resin, alkoxyalkylated melamine resins such as methoxymethylated melamine resin, ethoxymethylated melamine resin, propoxymethylated melamine resin, butoxymethylated melamine resin, bezoquamine resins, glycouril resins, urea resins, and mixtures thereof are used in combination with an acid catalyst. Other methods of crosslinking starches can be used, with or without acid catalysis, such as citric acid, malonic acid, epichlorohydrin, glyoxal, sodium trimetaphosphate, and phosphorus oxychloride.

Examples of catalysts include heat-activated or high energy (UV, electron beam, etc.) activated catalysts. In one example, the catalyst is polymeric or an oligomer. In one example, the catalyst is a blocked or unblocked sulfonic acid catalyst. In one example, the catalyst is an amine-blocked p-toluene sulfonic acid, an amine-blocked dodecylbenzene sulfonic acid, p-toluene sulfonic acid, dinonylnaphthalene disulfonic acid, dinonylnaphthylsulfonic acid, 2-dodecylbenzenesulfonic acid, citric acid, malonic acid, mineral acid (phosphoric acid, sulfuric acid, hydrochloric acid, nitric acid) and the like. Suitable catalysts are commercially available, for example, CYCAT® products from Allnex (Alpharetta, GA). One or more catalysts can be used. One or more catalyst accelerants can be used.

In one example, the starch-based laminating adhesive comprises about 10-90 weight percent (wt. %) solids of at least one synthetic, chemically or thermally modified starch, the remainder essentially water. In one example, the ratio of starch(es) to water is about 0.5:1 to about 1:0.5. In one example, the amount of crosslinking resin used is about 0.1 to about 10 wt. % to that of the total weight of starch.

In one example, the amount of crosslinking resin used is about 0.5 to about 5 wt. % to that of the total weight of starch. In one example, the amount of crosslinking resin used is about 0.75 to about 2.5 wt. % to that of the total weight of starch.

In one example, the amount of catalyst used is about 0.05 to about 2 wt. % to that of the total weight of starch. In one example, the amount of catalyst used is about 0.1 to about 1 wt. % to that of the total weight of starch. In one example, the amount of crosslinker for the starch laminating adhesive is present in a quantity such that the laminating adhesive does not substantially rewet when the water-activated tape is dispensed, yet at least partially solubilizes during paper repulping. In one example, the amount of catalyst used is added in a quantity such that the laminating adhesive does not substantially rewet when the water-activated tape is dispensed, or after the tape is applied, e.g., the laminating adhesive does not substantially rewet upon exposure to environmental moisture, yet the tape is at least 60% or more repulpable.

The innermost paper layer 112 has a first major (top) surface proximal to the reinforcement 122, and a second major (bottom) surface distal to the outermost paper layer 124. The innermost paper layer 112 has essentially an unlimited length, and has a width, defined by a first side and a second side that is less than the length. The first major (top) surface and the second major (bottom) surface of the innermost paper layer 112 defines a thickness. In one example, the thickness of the innermost paper layer 112 is chosen for the intended use of the tape product. In one example, the thickness of the innermost paper layer 112 and the outermost paper layer 124 are the same. In one example, the thickness of the innermost paper layer 112 and the outermost paper layer 124 are different.

The second major (bottom) surface of the innermost paper layer 112 receives the water-activated adhesive layer 114. In one example, the water-activated adhesive layer 114 is present at a thickness of between 0.5 and 1.0 mil. In one example, the water-activated adhesive layer 114 is adjacent to the second major (bottom) surface of the innermost paper layer 112. In one example, the water-activated adhesive layer 114 is directly adjacent to the second major (bottom) surface of the innermost paper layer 112, whereas there are no intervening layers or material therebetween.

Water-activated adhesive layer 114 may be applied to the innermost paper layer 112 as an aqueous or non-aqueous solvent-cast, solventless, or as molten film or as a coating layer using either extrusion, any manner of roll, knife, rod, die, or blade coating, curtain coating or any suitable coating method.

Water-activated adhesive layer 114 can be any conventional water-activated adhesive. In one example, the water-activated adhesive comprises a botanical or synthetic starch or blend thereof as described above. In one example, the water-activated adhesive comprises one or more of a synthetic or botanical starch, or blend thereof. In one example, the water-activated adhesive comprises one or more of a synthetic or botanical starch combined or blended with one or more polymers. In one example, the water-activated adhesive comprises one or more of a synthetic or botanical starch combined or blended with a polyacrylic acid polymer or copolymer. In one example, the water-activated adhesive comprises one or more of a synthetic or botanical starch combined or blended with a polyacryamide polymer or copolymer.

In one example, the starch used in the water-activated adhesive is the same as the starch used in the laminating adhesive. In another example, the starch used in the water-activated adhesive is different from the starch used in the laminating adhesive. The water-activated adhesive needs to rewet to adhere to a carton; the laminating adhesive is crosslinked to prevent rewetting during water activation of the tape during dispensing, with the proviso that the degree of crosslinking, if any, is such that the repulpability of the tape is substantially maintained.

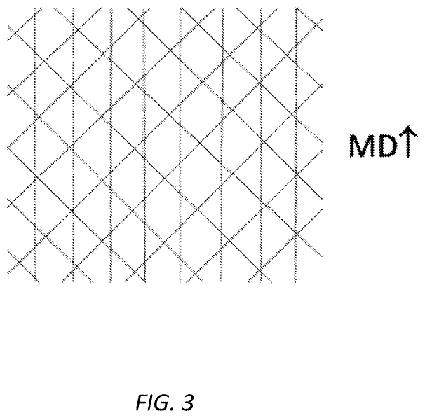

In one example, reinforcement 122 can be tape, ribbon, or yarn with the tape ribbon or yarn arranged in any combination of orientations. In one example, reinforcement 122 is tape, ribbon, or yarn that is at least partially machine-direction (MD) oriented, which include cross-hatched, diagonal, or arrangements of tape, ribbon, or yarn. As shown in FIG. 3, in one example, tri-directional yarn reinforcement is used as reinforcement 122. Tape, ribbon, or yarns of reinforcement 122 can be selected from organic, inorganic, or composite organic-inorganic materials. In one example, yarns of reinforcement 122 are selected from organic polymers or copolymers. In one example, reinforcements used in the presently disclosed water-activated tape as well as reinforced water-activated tapes are selected from materials that at least partially dissolve and/or can be incorporated into kraft (sulfate) paper repulping process under typical and/or standard conditions using one or more chemicals and/or heat, for example, sodium hydroxide, sodium hypochlorite, hydrogen peroxide, polyethylene glycol and combinations thereof.

In one example, the reinforcement comprises bi- or tri-directional tape, ribbon, or yarn. In one example, the reinforcement comprises bi- or tri-directional tape, ribbon, or yarn comprising polyester or glass (fiberglass). In one example, the reinforcement comprises bi- or tri-directional fiberglass having a base weight of about 3-7 grams per square meter. In one example, the reinforcement comprises tri-directional fiberglass having a base weight of about 5-6 grams per square meter. Suitable tri-directional glass fiber for use as reinforcement 122 is available from St. Gobain Adfors, such as TGC2211/A. Other glass or polymer yarns can be used as the reinforcement 122.

In one example, ribbon, tapes, or yarns of reinforcement 122 are selected from at least partially sustainable organic polymers or copolymers. In one example, ribbon, tapes, or yarns of reinforcement 122 are selected from polyvinyl alcohol polymers, polyvinyl alcohol copolymers, blends of polyvinyl alcohol polymers and polyvinyl alcohol copolymers of the same or different molecular weights, the same or different degree of saponification, and the same or different chemical composition. As used herein, polyvinyl alcohol (PVOH) (co)polymers are inclusive of plasticized PVOH material. The plasticizer system of the plasticized PVOH can be one, or a combination of conventional plasticizers including polyhydric alcohols, waxes, hydrocarbon oil, mineral oil, polyethylene glycol, propylene glycol, polyethylene oxide, polypropylene oxide, glycerine, mannitol, pentaerythritol, trimethylpropane, starch, chitosan, erythritol, polyethylene amines, and ionic polymers. Other plasticizers and/or plasticizing systems can be used.

In one example, ribbon, tapes, or yarns of reinforcement 122 are selected from partially or substantially hydrolyzed polyvinyl acetate polymers, partially or substantially hydrolyzed polyvinyl acetate copolymers, blends of polyvinyl acetate polymers and polyvinyl acetate copolymers of the same or different molecular weights, the same or different degree of acetate content, and the same or different chemical composition.

In one example, ribbon, tapes, or yarns of reinforcement 122 are selected from blends of partially or substantially hydrolyzed polyvinyl acetate polymers with polyvinyl alcohol polymers and polyvinyl alcohol copolymers. Such blends can comprise a plurality of polyvinyl acetate copolymers, polyvinyl acetate (co)polymers and polyvinyl alcohol (co)copolymers of the same or different molecular weights, the same or different degree of acetate content or degree of saponification, and the same or different chemical composition.

In one example, ribbon, tapes, or yarns of reinforcement 122 are selected from blends of partially or substantially hydrolyzed polyvinyl alcohol polymers and ionic polymers or ionic copolymers. Such blends can comprise a plurality of polyvinyl alcohol (co)copolymers and ionic (co)polymers of the same or different molecular weights, the same or different degree of saponification, and the same or different chemical composition. Other partially water-soluble or at least partially alkaline soluble polymer yarns can be used as reinforcement 122.

In one example, the reinforcement 122 of the present disclosure can comprise PVOH tape, ribbon, or yarn of one or more of commercially available products. Commercially available PVOH yarns include SOLVRON® yarns from Nitivy (Tokyo, Japan).

The water-activated adhesive 114 may be any conventional water-activated adhesive or hereinafter developed adhesive suitable for box sealing or carton sealing tapes (also referred to as packaging tapes). In one example, the water-activated adhesive 114 comprises a botanical starch or a botanical starch blended with one or more polymers. In one example, the water-activated adhesive 114 comprises a chemically, mechanically, or thermally modified botanical starch, or a chemically, mechanically, or thermally modified botanical starch blended with one or more polymers.

The water-activated adhesive 114 may be applied to the innermost paper layer 112 as a solvent-cast, solventless, or molten film or as a coating layer using either extrusion, any manner of roll, knife, rod, or blade coating, curtain coating or any suitable method. In one example, the water-activated adhesive 114 is present at a thickness of about 0.5 mil to about 1.0 mil. Other thickness of the water-activated adhesive 114 can be used.

The starch-based laminating adhesive comprises a material that can be concentrated, diluted, softened or heated for lamination and will laminate the outermost paper 124, the reinforcement, and the innermost paper layer 112. Typically, the starch-based laminating adhesive is capable of forming a bond between the outermost paper layer 124, reinforcement 122, and innermost paper layer 112. In one example, the starch-based laminating adhesive strength and the water-activated adhesive strength, under dry bond conditions, is essentially the same. In one example, after manufacture of the tape of the present disclosure, the starch-based laminating adhesive strength will be greater than the water-activated tape adhesive strength, after rewetting, for example, during water activation prior to placement on a carton.

Optionally, one or more additives for inclusion in any of the above layers include one or more of UV inhibitors, antioxidants, pigments, and antistatic agents, but are not limited thereto.

Innermost and outermost paper layers 112, 124, respectively, may be the same or different paper composition, thickness, color etc. In one example, the innermost and outermost paper layers 112, 124, respectively, are any type of paper including, but not limited to, creped paper, non-creped paper, or release paper. In one example, kraft paper, e.g. bleached or natural kraft paper, is used as the innermost and outermost paper layers 112, 124, respectively. In one example, the innermost and outermost paper layers 112, 124, respectively, is a bleached or unbleached kraft paper. In one example, the innermost and outermost paper layers 112, 124, respectively, are creped NBSK (Northern Bleached Softwood kraft) paper web.

In one example, the water-activated adhesive layer 114 is present at a thickness necessary to impart sufficient or desired sealing properties to a box or package when used for its intended purpose. For example, the water-activated adhesive layer 114 is present at a thickness of about 0.5 mil to about 1.0 mil. The water-activated adhesive layer 114 may be any conventional water-activated adhesive or hereinafter developed adhesive suitable for box sealing or carton sealing tapes (also referred to as packaging tapes). In one example, the water-activated adhesive layer 114 is based on a starch, e.g., a chemically or thermally modified starch. Examples of starches useful for the water-activated adhesive layer 114, include, but are not limited to, cassava, corn, sorghum, wheat, sago, tapioca, legumes, barley, rice, and/or potatoes.

A continuous method of manufacturing the water-activated tapes of the present disclosure includes providing a water-activated paper tape comprising a innermost paper layer having a water-activated adhesive defining a bottom major surface thereof, and extrusion laminating to the innermost paper layer, opposite the water-activated adhesive, a reinforcement and paper backing. The extrusion laminating disposes the innermost lamination layer contiguous to the innermost paper layer and includes extrusion lamination of the reinforcement, paper backing, and gummed paper together. The method may also include winding the tape onto a roll and slitting the rolled tape into a plurality of rolls of reinforced water-activation tape.

### EXAMPLES

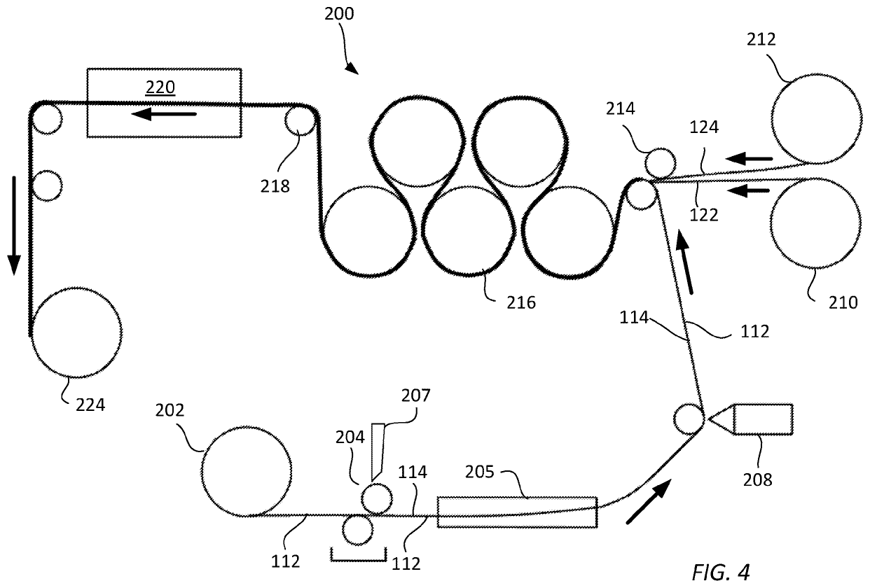

As illustrated in FIG. 4, an exemplary manufacturing process is depicted, where a top ply of white kraft paper is laminated to a reinforcement and a gummed paper ply with a laminating adhesive comprising starch or starch derivative, a crosslinker, and optionally, an acid catalyst. With reference to FIG. 4, an exemplary manufacture process 200 for the presently disclosed water-activated tape 100 is shown. Innermost paper layer 112 is unwound from roll 202 and water-activated adhesive 114 is applied to the bottom major surface of the innermost paper layer 112 via reverse roll coater 207 and dried in forced hot air oven 205. Gummed innermost paper layer 112 with dried water-activated adhesive 114 on bottom side then is coated with starch-based laminate adhesive on the top side thereof, for example, via slot die 208. Gummed innermost paper layer 112 with dried water-activated adhesive 114 on bottom side and starch-based laminate adhesive on top side, is joined with reinforcement 122, for example, from roll 210, and outermost paper layer 124 from roll 212 and fed into nip rolls 214. Nip rolls 214 can be heated. Tape 100 can be at least partially dried via drying rolls (dryer cans) 216 and then further dried and/or cured/crosslinked, for example via Festoon oven 220 prior to take-up on finishing roll 224. Tape 100 can be cut to desired width using conventional methods.

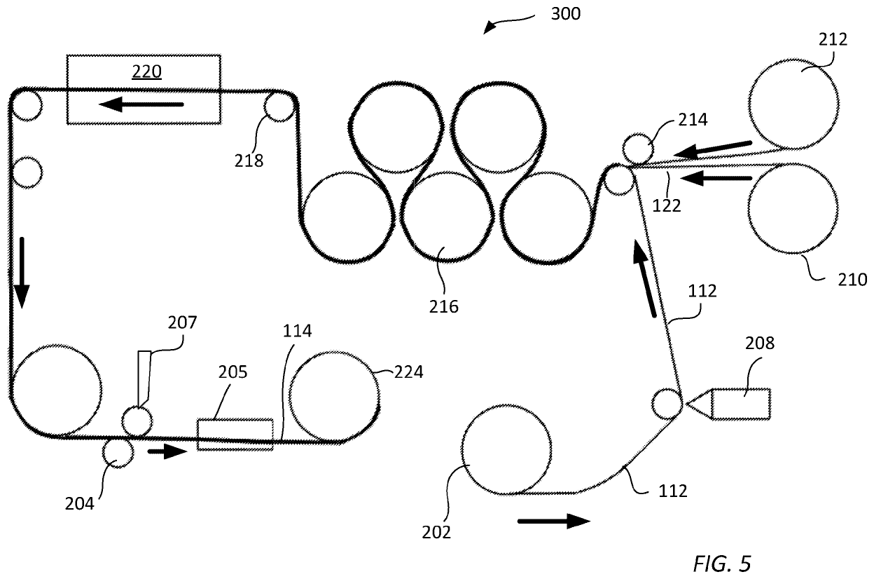

With reference to FIG. 5, another exemplary manufacture process 300 for the presently disclosed water-activated tape 100 is shown. Innermost paper layer 112, unwound from roll 202, is coated with starch-based laminating adhesive on the top side thereof, for example, via slot die 208. Innermost paper layer 112 and starch-based laminate adhesive on top side, is joined with reinforcement 122, for example, from roll 210 and outermost paper layer 124 from roll 212 and fed between nip rolls 214. Nip rolls 214 can be heated. Tape 200 can be at least partially dried via drying rolls (dryer cans) 216 and then further dried and/or optionally cured/crosslinked, for example via Festoon oven 220. Water-activated adhesive 114 is applied to the bottom major surface of the innermost paper layer 112 via reverse roll coater 207 and dried in forced hot air oven 205. Gummed innermost paper layer 112 with dried water-activated adhesive 114 on bottom side is then taken-up on finishing roll 224. Tape 100 can be cut to desired width using conventional methods.

While certain examples of the present disclosure have been illustrated with reference to specific combinations of elements, various other combinations may also be provided without departing from the teachings of the present disclosure. Thus, the present disclosure should not be construed as being limited to the particular examples described herein and illustrated in the Figures, but may also encompass combinations of elements of the various illustrated examples and aspects thereof.

1. A water-activated tape comprising:
an outermost paper layer having a top surface and a bottom surface;
a reinforcement adjacent to the bottom surface of the outermost paper layer;
an innermost paper layer having a top surface and a bottom surface, the top surface of the innermost paper layer adjacent to the reinforcement;
at least a portion of a starch-based laminating adhesive disposed about each of the outermost paper layer, reinforcement, and innermost paper layer; and
a water-activated adhesive adjacent to the bottom surface of the innermost paper layer.

2. The water-activated tape of claim 1, wherein one or both of the innermost paper layer and the outermost paper layer comprises bleached or natural kraft paper.

3. The water-activated tape of claim 1, wherein the reinforcement comprises tape, ribbon, or yarn of polymer and/or glass.

4. The water-activated tape of claim 3, wherein the reinforcement comprises uni-, bi- or tri-directional tape, ribbon, or yarn of polymer, glass, and/or water-soluble polymer.

5. The water-activated tape of claim 1, wherein the starch-based laminating adhesive comprises: one or more botanical or synthetic starches; one or more botanical or synthetic starches in combination with one or more polymers; one or more of a synthetic starch, a chemically-, an enzymatically-, a mechanically-, a thermally-modified botanical starch and blends thereof; or one or more of a synthetic starch, a chemically-, an enzymatically-, a mechanically-, and a thermally-modified botanical starch blended with one or more polymers.

6. The water-activated tape of claim 1, wherein the starch-based laminating adhesive is contiguous or semi-contiguous to the innermost paper layer, outermost paper, and the reinforcements.

7. The water-activated tape of claim 1, wherein the starch-based laminating adhesive further comprises a crosslinker and optionally a catalyst.

8. The water-activated tape of claim 7, wherein the crosslinker comprises one or more of a melamine resin or melamine polymer, alkoxylated melamine resin, bezoquamine resin, glycouril resin, urea resin, and mixtures thereof.

9. The water-activated tape of claim 7, wherein the catalyst is a blocked or unblocked sulfonic acid catalyst or mineral acid.

10. The water-activated tape of claim 8, wherein the water-activated adhesive comprises one or more of a botanical starch, synthetic starch, a chemically-, an enzymatically-, a mechanically-, a thermally-modified botanical starch, and blends thereof with one or more polymers.

11. The water-activated tape of claim 1, wherein the starch-based laminating adhesive: resists wetting during dispensing and activation of the water-activated adhesive; and has sufficient solubility for repulpability.

12. A method of making a repulpable water-activated tape comprising:
laminating to a reinforcement using at least one starch-based laminating adhesive:
a top major surface of an innermost paper layer having a bottom major surface having a water-activated adhesive thereon; and
a bottom major surface of an outermost paper layer;
wherein the reinforcement is positioned between the top major surface of the innermost paper layer and the bottom major surface of the outermost paper layer.

13. The method of claim 12, wherein the starch-based laminating adhesive is contiguous or semi-contiguous to the innermost paper layer, outermost paper, and the reinforcement.

14. The method of claim 12, wherein the starch-based laminating adhesive comprises: one or more botanical or synthetic starches; one or more botanical or synthetic starches in combination with one or more polymers; one or more of a synthetic starch, a chemically-, an enzymatically-, a mechanically-, a thermally-modified botanical starch and blends thereof; or one or more of a synthetic starch, a chemically-, an enzymatically-, a mechanically-, and a thermally-modified botanical starch blended with one or more polymers.

15. The method of claim 12, wherein the starch-based laminating adhesive further comprises a crosslinker, and optionally, a catalyst.

16. The method of claim 15, wherein the crosslinker is one or more of methylated melamine formaldehyde, methoxymethylated melamine, ethoxymethylated melamine, propoxymethylated melamine, butoxymethylated melamine, hexamethylol melamine, ethoxymethylated melamine, propoxymethylated melamine, butoxymethylated melamine, bezoquamine resin, glycouril resin, urea resin, and mixtures thereof.

17. The method of claim 15, wherein the catalyst is a blocked or unblocked sulfonic acid catalyst or a mineral acid.

18. The method of claim 12, wherein the water-activated adhesive comprises one or more of a botanical starch, synthetic starch, a chemically-, an enzymatically-, a mechanically-, a thermally-modified botanical starch, and blends thereof with one or more polymers.

19. The method of claim 12, wherein one or both of the innermost paper layer and the outermost paper layer comprises kraft paper.

20. The method of claim 12, wherein the reinforcement comprises tape, ribbon, or yarn of polymer and/or glass.

21. The method of claim 20, wherein the reinforcement comprises bi- or tri-directional tape, ribbon, or yarn of polymer, glass, and/or water-soluble polymer.

22. A starch-based laminating adhesive comprising:
one or more of a botanical starch and synthetic starch;
one or more of botanical starch and synthetic starch combined with one or more polymers;
one or more of a botanical starch, a synthetic starch, a chemically-, an enzymatically-, a mechanically-, and a thermally-modified botanical starch; or
one or more of a botanical starch, a synthetic starch, a chemically-, an enzymatically-, a mechanically-, a thermally-modified botanical starch combined with one or more polymers.
